(19) United States
(12) Patent Application Publication
(10) Pub. No.: US 2011/0235709 A1
(43) Pub. Date: Sep. 29, 2011

(54) FRAME DROPPING ALGORITHM FOR FAST ADAPTATION OF BUFFERED COMPRESSED VIDEO TO NETWORK CONDITION CHANGES

(75) Inventors: Xiaojin SHI, Fremont, CA (US); Xiaosong ZHOU, Campbell, CA (US); Joe ABUAN, San Jose, CA (US); Hyeonkuk JEONG, Saratoga, CA (US); Jochen Christian SCHMIDT, San Francisco, CA (US); Yan YANG, San Jose, CA (US); James Oliver NORMILE, Los Altos, CA (US); Hsi-Jung WU, San Jose, CA (US)

(73) Assignee: APPLE INC., Cupertino, CA (US)

(21) Appl. No.: 12/756,100

(22) Filed: Apr. 7, 2010

Related U.S. Application Data
(60) Provisional application No. 61/317,625, filed on Mar. 25, 2010.

(51) Int. Cl. H04N 7/26; H04N 7/32

(52) U.S. Cl. 375/240.12; 375/240.01; 375/240.26; 375/E07.243

(57) ABSTRACT

A video coding and transmission system may employ techniques for adapting buffered video to network condition changes. Video data may be coded as reference data and non-reference data. According to the embodiments, non-reference frame may be detected in buffered video while awaiting transmission to a network. When network degradation is detected, one or more of the buffered non-reference frames may be dropped when network degradation is detected. Information about the dropped frames may be passed to an encoder for updating buffer parameters for future encoding. In this manner, a video coding system may provide faster responses to changing network conditions than systems without such buffer management techniques.

The present application claims the benefit of U.S. Provisional Application Ser. No. 61/317,625, filed Mar. 25, 2010, entitled “Frame Dropping Algorithm for Fast Adaptation of Buffered Compressed Video to Network Condition Changes,” the disclosure of which is incorporated herein by reference in its entirety.

### BACKGROUND

Video conferencing over high latency, high jitter, and low bandwidth networks is a challenging problem, especially when network conditions change dynamically. To smooth out the impact of network condition changes, a buffer can be implemented between the network layer and codec layer. Based on the estimation of current network conditions, the network layer sets buffer parameters for the encoder. Next, the encoder may calculate buffer status based on these parameters, and encode a source video sequence using coding parameters that are based in part on the buffer condition. Once the encoder codes a frame, it outputs the frame to a transmit buffer for use by the network layer. The encoder employs predictive coding techniques to reduce bandwidth of the coded video signal. These predictive techniques rely on an implicit guarantee that all coded data will be transmitted by the network layer once generated by the encoder.

However, due to potentially quick changes in network conditions, e.g., link failure, bandwidth reduction, and high feedback latency, the buffer condition may not match the instantaneous network condition. For example, during a video conference session, bandwidth may drop significantly in a short period of time. In this case, conventional coding systems require the network layer to transmit all frames generated by the encoder even when network bandwidth drops materially. This operation may contribute to degraded performance when network conditions degrade. Accordingly, there is a need for a video coder and control system that responds dynamically to dynamic changes in network conditions.

### BRIEF DESCRIPTION OF THE DRAWINGS

FIG. 1 is a functional block diagram of a videoconferencing system according to an embodiment of the present invention.

FIG. 2 is a functional block diagram of a coding chain and control chain for a videoconferencing terminal according to an embodiment of the present invention.

FIG. 3 is a state diagram illustrating operation of a coder control chain according to an embodiment of the present invention.

FIGS. 4-6 illustrate various examples of different coding parameters that might be used when a coding control chain switches between a stable coding state and an unstable state, according to the present invention.

### DETAILED DESCRIPTION

Embodiments of the present invention provide techniques for adapting buffered video to network condition changes. Video data may be coded as reference data and non-reference data. According to the embodiments, non-reference frame may be detected in buffered video while awaiting transmission to a network. When network degradation is detected, one or more of the buffered non-reference frames may be dropped when network degradation is detected. Information about the dropped frames may be passed to an encoder for updating buffer parameters for future encoding. In this manner, a video coding system may provide faster responses to changing network conditions.

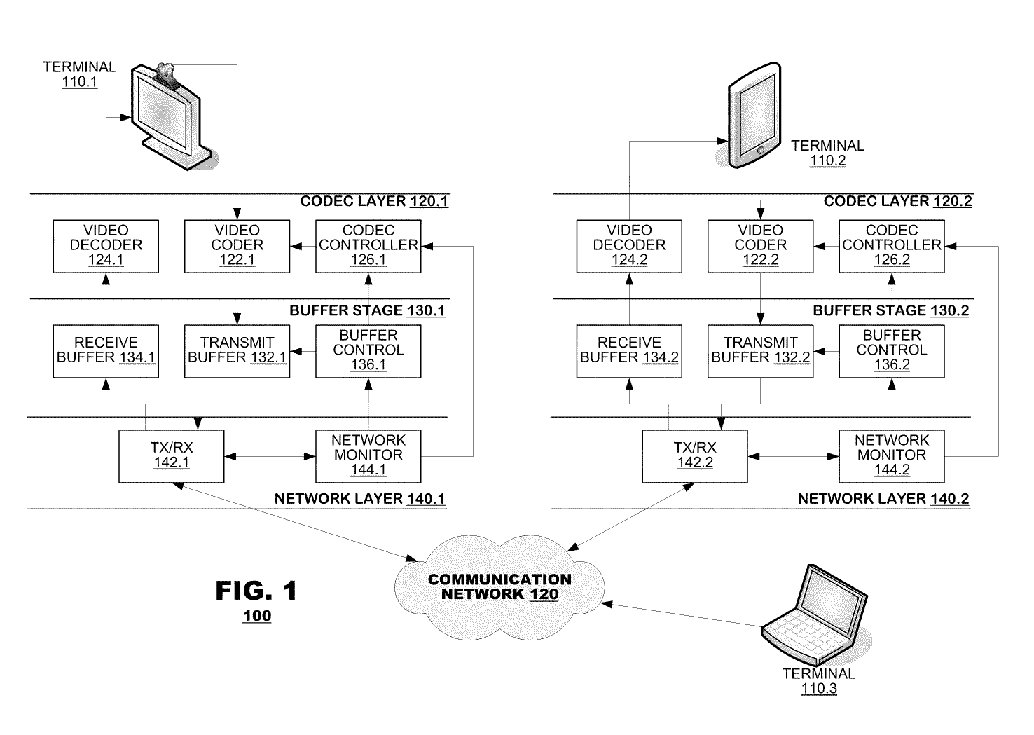

FIG. 1 is a functional block diagram of a videoconferencing system 100 according to an embodiment of the present invention. The videoconferencing system 100 may include a plurality of communication terminals 110.1, 110.2 provided in communication with each other via a communication network 120. The terminals 110.1, 110.2 may include respective video cameras, microphones, displays and speakers (not shown) to capture audio/video data at a near-end location and render audio/video data delivered to the respective terminal 110.1, 110.2 from a far-end location. The communication network 120 may provide communication channels between the respective terminals via wired or wireless communication networks, for example, the communication services provided by packet-based Internet or mobile communication networks (e.g., 3G and 4G wireless networks). Although only two terminals are described in detail, the videoconferencing system 100 may include additional terminals (e.g., 110.3) provided in mutual communication for multipoint videoconferences.

FIG. 1 illustrates functional blocks of video processes that operate on captured and rendered video data according to an embodiment of the present invention. For example, the terminals 110.1, 110.2 may include respective codec layers 120.1, 120.2, buffer stages 130.1, 130.2 and network layers 140.1, 140.2. The codec layers 120.1, 120.2 may perform video coding and decoding operations that exploit temporal and spatial redundancies in video data to compress the data for transmission over the network 120. The codec layers 120.1, 120.2 may include respective video coders 122.1, 122.2 that code near end source video according to a video coding protocol, such as the known ITU H.263, H.264 or MPEG family of protocols, and generate coded video data therefrom. The codec layers 120.1, 120.2 further may include respective video decoders 124.1, 124.2 that decode coded video data received from a far-end terminal for display on a near-end display device. The codec layers 120.1, 120.2 may include respective codec controllers 126.1, 126.2 that select coding parameters to be used by the video coders 122.1, 122.2.

The buffer stages 130.1, 130.2 may include respective transmit buffers 132.1, 132.2, receive buffers 134.1, 134.2 and buffer controllers 136.1, 136.2. The transmit buffers 132.1, 132.2 may receive coded video data from the respective video coders 122.1, 122.2 and hold it in queue until needed by the network layer 140.1, 140.2. Similarly, the receive buffers 134.1, 134.2 may store coded video data provided by the respective network layers 140.1, 140.2 and store it in queue until consumed by the video decoders 124.1, 124.2. Buffer controllers 136.1, 136.2 may manage operations of the transmit buffer 132.1, 132.2 and may perform queue decimation as needed to accommodate network degradation events.

The network layers 140.1, 140.2 may include respective transceivers 142.1, 142.2 and network monitors 144.1, 144.2. The transceivers 142.1, 142.2 may receive data from the transmit buffers 132.1, 132.2, format it for transmission over the communication network 120 and transmit the data. The transceivers 142.1, 142.2 also may receive data from the communication network 120 and process the data to format it for consumption at the terminal. In so doing, the transceivers 142.1, 142.2 may perform error recovery processes to recover from data transmission errors that may have been induced by the communication network 120. The network monitors 144.1, 144.2 may monitor execution of these error recovery processes and estimate other network performance metrics to determine the operational state of the network 120. For example, the network monitors 144.1, 144.2 may estimate transmitted packet loss rate from negative acknowledgment messages (commonly, “NACKs”) received from far-end transmitters. The network monitors 144.1, 144.2 may estimate packet arrival time jitter based on received packets. They may estimate round trip communication latency on one-way latency based on packets delivered to the network and packets received therefrom. The network monitors 144.1, 144.2 also may exchange messages between them, transmitted by the transceivers 142.1, 142.2, identifying to the other the packet transmission rate and/or packet arrival rates at the respective transceivers 142.1, 142.2. In an embodiment of the present invention, the network monitors 144.1, 144.2 may estimate operational state of the network 120 and report indicators of the operational state to the buffer controllers 136.1, 136.2 and the codec controllers 126.1, 126.2. The codec controllers 126.1, 126.2 and buffer controllers 136.1, 136.2 may adjust their operation based on operational state as determined by the network monitors 144.1, 144.2.

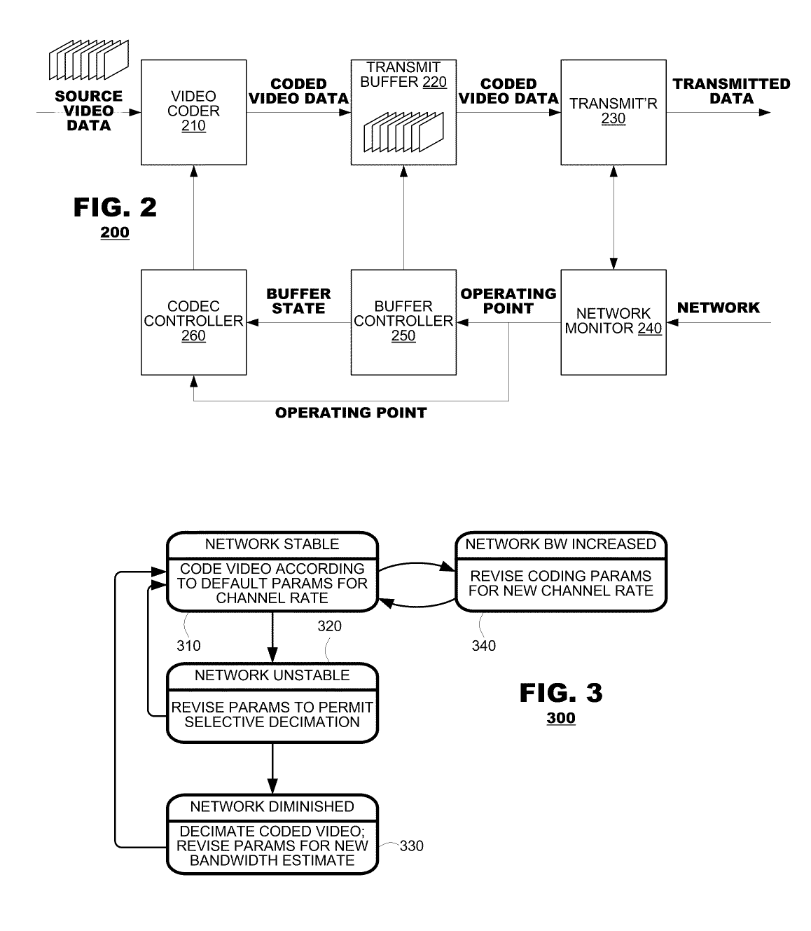

FIG. 2 is a functional block diagram of a coding chain and control chain for a videoconferencing terminal according to an embodiment of the present invention. As noted, the coding chain may include a video coder 210, transmit buffer 220 and transmitter 230. The control chain may include a network monitor 240, buffer controller 250 and codec controller 260. The video coder 210 may code a sequence of source video data according to a predetermined coding protocol to generate coded video data. The video coder 210 may code the source video according to coding parameter selections provided to it by the coded controller 260 defining properties of the coded video data. Such coding parameters can include channel rate, frame rate, frame size and/or scalability. As discussed herein, when the codec controller 260 receives revised operating point data from the network monitor 240, the coded controller 260 revise its selection of coding parameters and cause the video coder 210 to alter its operation to match.

As noted, the transmit buffer 220 may store coded video data until it is read out by the transmitter 230 for transmission to the network. The transmit buffer 220 may operate under control of a buffer controller 250, which receives data representing the network operating point from the network monitor 240. In an embodiment, when the buffer controller 250 receives revised operating point data from the network monitor 240 indicating diminished bandwidth available from the network, the buffer controller 250 may selectively decimate coded video data in the buffer. If the buffer controller 250 decimates data in the buffer 220, it may report the decimating to the codec controller 260.

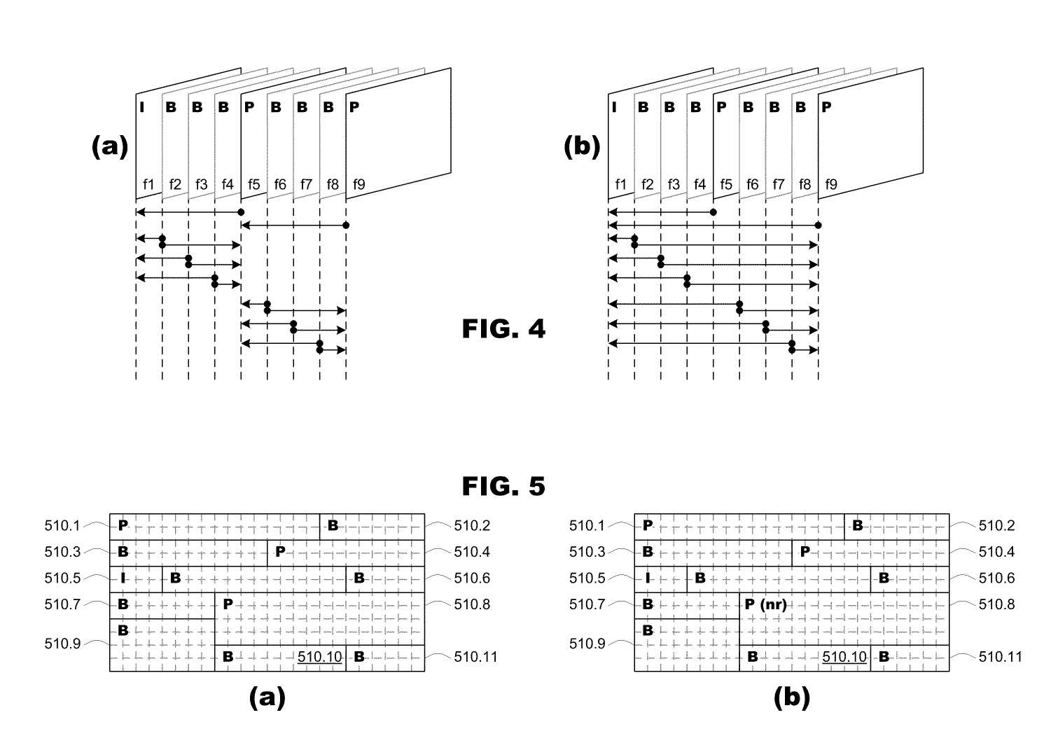

FIG. 3 is a state diagram 300 illustrating operation of a coder control chain according to an embodiment of the present invention. State 310 illustrates control operations that may occur when a network monitor determines the network is in a stable operating condition—when the bandwidth provided by the network matches the channel rate parameter currently used by the video coder. In the stable operating state 310, the video coder may continue to code data according to the then-current set of coding parameters.

State 320 illustrates control operations that may occur when a network monitor determines the network is in an unstable operating condition. The “unstable” state 320 may be one in which network statistics indicate a greater number of communication errors than are expected in stable operation but the network statistics do not clearly show that the network is not capable of carrying data at the currently assigned channel rate. In this case, the coder controller may revise coding parameters to decrease the rate of data dependencies among portions of coded video data but need not revise the channel rate at which the coder currently is working. The coder control chain may exit the unstable state 320 by returning to the stable state 310 if communication errors return to expected levels over time. Alternatively, the coder control chain may exit the unstable state 320 by advancing to a network diminished state 330.

The network diminished state 330 may represent a state in which network conditions generate unacceptable transmission errors at a currently-assigned channel rate. In the network diminished state 330, a buffer controller 250 (FIG. 2) may respond by selectively decimating coded data stored in the transmit buffer 220 but not read out by the transmitter 230. The buffer controller 250 further may identify decimated data to the codec controller 260 for use in determining prediction references among source video data not yet coded. Further, the codec controller 260 may revise its channel rate parameter to accommodate newly estimated network bandwidth. The coding control chain may exit to the network stable state 310 when the codec controller 260 identifies a channel rate that is compatible with the estimated network bandwidth.

Selective decimation may occur immediately when the system enters the network diminished state 330. In such an embodiment, the system may identify and delete coded video data present in the transmit buffer 220 in a single atomic act.

Alternatively, the system may perform selective decimation by scheduling different elements of coded video data for prioritized transmission. In such an embodiment, the system may schedule coded reference data for prioritized transmission and may schedule data elements that are candidates for deletion at lower priority. The system may transmit the high priority data first and, if network resources permit transmission of lower priority elements, the network may transmit the lower priority elements as well. The transmit buffer 220 may operate on a pipelined basis, receiving new coded video data as other video data is read out and transmitted by the network layer. Thus, the transmit buffer 220 may receive other elements of video data that are higher priority than lower priority elements already stored by the transmit buffer 220. Again, the higher priority elements may be scheduled for transmission over the lower priority elements. At some point, various lower priority elements may expire within the transmit buffer 220 and be deleted prior to transmission.

FIG. 3 also illustrates a state 340 corresponding to an increase in network bandwidth. The coder control chain may estimate increases in network bandwidth according to any of a number of available techniques including, for example, co-pending application Ser. No. 12/646,065 entitled “Joint Bandwidth Detection Algorithm for Real-Time Communication,” assigned to Apple Corp.

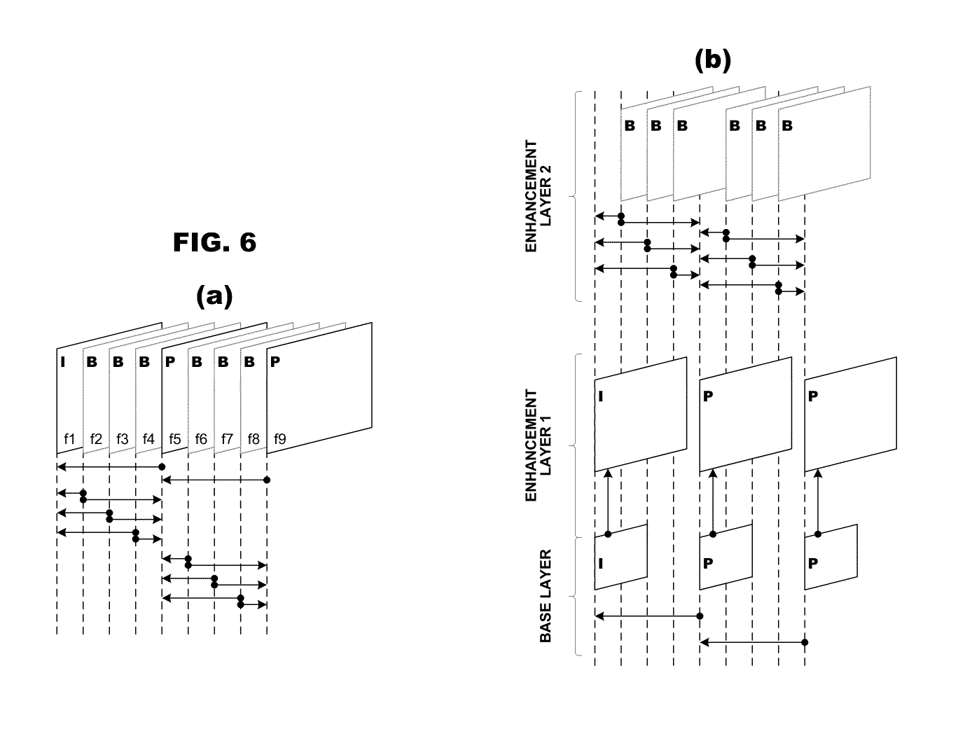

FIGS. 4-6 illustrate various examples of different coding parameters that might be used when a coding control chain switches between a stable coding state and an unstable state, according to the present invention. FIG. 4, for example, illustrates adjustment of prediction dependencies that may occur as a coder control chain advances from the network stable state to a network unstable state. FIG. 4(a) illustrates coding dependencies that may exist among nine (9) frames of video data coded according to an IBBBP pattern. Frame 1 is illustrated as an I frame, coded according to intra-coding techniques. Frames F5 and FF9 are illustrated as coded as P frames, which are coded according to unidirectional predictive coding techniques and look to one other frame as a prediction reference. Frames F2-F4 and F6-F8 are illustrated as coded according to bidirectional predictive coding techniques; B frames look to two other frames as prediction references.

FIG. 4(a) illustrates P frame F5 relying on I frame F1 as a prediction reference and P frame F9 relying on P frame F5 as a prediction reference. Moreover, B frames F2-F4 and F6-F8 rely on P frame F5 as a prediction reference. FIG. 4(b) illustrates changes that may occur when a coding control chain advances to the network unstable state. In this example, P frames F5 and F9 both rely on a common I frame as a prediction reference. Moreover, B frames F2-F4 and F6-F8 rely on P frame 9 as a prediction reference instead of P frame F5 as illustrated in FIG. 4(a). In the example of FIG. 4(b), P frame F5 is a non-reference frame—it does not serve as a prediction reference for any other frame. If the coding control chain deleted the non-reference frame f5 prior to transmission, deletion of the frame would not materially diminish the quality of a recovered video sequence at a decoder. By contrast, if frame F5 served as a reference frame and were deleted prior to transmission, it could materially diminish quality of a recovered video sequence. In the FIG. 4(a) example, a decoder could not recover frames F2-F4 or F6-F8 if frame F5 were lost.

FIG. 5 illustrates another example of reduction of prediction references, according to an embodiment of the present invention. FIG. 5(a) illustrates an exemplary frame of video data coded as a plurality of slices 510.1-510.11. Blocks of video data within each slice may be coded according to an intra-coding (I) mode, predictive coding (P) mode or bidirectionally-predictive coding (B) mode. Slices coded according to I or P mode generally are available as prediction references for blocks or slices of other frames. According to an embodiment of the present invention, when the coding control chain enters a network unstable state, various P slices may be marked as non-reference slices. FIG. 5(b) illustrates an example where slice 510.8 may be marked as a non-reference slice. The slice 510.8 would not be used as a prediction reference for any other data. If it were deleted from a transmission queue if the system entered a network diminished state, a recovered video signal would have fewer artifacts than if the slice were used as a prediction reference for other blocks or slices.

FIG. 6 illustrates another example of system response when the system moves from a network stable state to an unstable state. FIG. 6(a) illustrates prediction dependencies that may be employed when the network is operating in a stable state. The example of FIG. 6(a) mimics the example of FIG. 4(a) in this regard. FIG. 6(b) illustrates the same video sequence coded according to multi-layer scalability. In this example, a base layer includes reference frames coded at a base level of image quality. For example the base layer frames may be coded at a small frame size as compared to the frames of FIG. 6(a). A first enhancement layer may include coded image data of the reference frames coded at a larger size. As is known, data of the enhancement layer cannot be decoded by itself; it must be decoded in conjunction with the base layer data. Decoding the base layer data and the first enhancement layer data, however, may generate a recovered video sequence that is of larger size than a recovered video sequence decoded from the base layer alone.

FIG. 6(b) also illustrates a second enhancement layer with coded video data of the B frames. The B frames of the second enhancement layer may refer to the reference frames of the base layer as prediction references. Decoding of the coded B frames from the second enhancement layer provides an increases display frame rate as compared to coding of the base layer and first enhancement layer.

By switching to scalable coding techniques when network instability is observed, it permits decimation of data in a transmit buffer if state advances to a network diminished state. Thus, data of the first and second enhancement layers may be deleted from a transmit buffer prior to transmission when the system advances to the network diminished state.

In another embodiment, in a network diminished state, the system may select and delete coded reference frames from the transmit buffer. In such an embodiment, the codec controller may cause the video coder to recode source video corresponding to the coded reference frame as a non-reference frame. The codec controller also may recode source video corresponding to coded data that depends on the reference frame. Such embodiments find application in systems in which the codec operates with sufficient throughput to repopulate the transmit buffer before the network layer would transmits the deleted coded reference data and coded dependent data.

The foregoing embodiments of the present invention provide several techniques for video coders to adapt quickly to bandwidth changes in transmission networks. It provides techniques to adapt video coder performance to changing network environments and also to adapt transmission of already-coded data. By adapting transmission of already-coded data in response to changing network conditions, it is expected the video coding systems of the present invention will respond more quickly to changing network conditions than conventional systems.

The foregoing embodiments provide a coding/control system that estimates network characteristics and adapts performance of an encoder and a transmit buffer to respond quickly to changing network characteristics. The techniques described above find application in both software- and hardware-based control systems. In a software-based control system, the functional units described hereinabove may be implemented on a computer system (commonly, a server, personal computer or mobile computing platform) executing program instructions corresponding to the functional blocks and methods listed above. The program instructions themselves may be stored in a storage device, such as an electrical, optical or magnetic storage medium, and executed by a processor of the computer system. In a hardware-based system, the functional blocks illustrated above may be provided in dedicated functional units of processing hardware, for example, digital signal processors, application specific integrated circuits, field programmable logic arrays and the like. The processing hardware may include state machines that perform the methods described in the foregoing discussion. The principles of the present invention also find application in hybrid systems of mixed hardware and software designs.

Several embodiments of the invention are specifically illustrated and/or described herein. However, it will be appreciated that modifications and variations of the invention are covered by the above teachings and within the purview of the appended claims without departing from the spirit and intended scope of the invention. For example, FIG. 1 illustrates a coding control chain provided for both terminals in a videoconference session but the principles of the present invention find application in a system in which only one terminal includes such functionality. It is expected that optimum performance will be achieved when all terminals have such functionality but improved performance may arise when even a single terminal operates in accordance with the present invention.

We claim:

1. A method for adapting buffered video to network condition changes, the method comprising:
detecting non-reference frames in buffered video awaiting output to a network;
dropping one or more of the non-reference frames when network degradation is detected; and
generating information about the dropped frames to pass to an encoder for updating buffer parameters for future encoding.

2. The method of claim 1 further comprising, when network degradation is detected, revising coding parameters of the encoder to match a revised estimate of network conditions.

3. The method of claim 1, further comprising, prior to detection of the network degradation:
coding video data according to predictive coding techniques, the coding generating non-reference frames and reference frames,
detecting network instability, and
when network instability is detected, coding the video data by a decreased number of reference frames.

4. The method of claim 3, wherein coding video data according to predictive coding techniques, the coding generating non-reference frames and reference frames,
detecting network instability, and
when network instability is detected, the encoder engages scalable video coding, coding source video data as coded base layer data and coded enhancement layer data, and
wherein the dropping is performed on frames of the coded enhancement layer data.

5. The method of claim 1, further comprising:
dropping buffered reference frames, and
re-coding source video data corresponding to the dropped reference frames as non-reference frames.

6. The method of claim 5, further comprising:
dropping buffered coded data that relies on the dropped reference frames as a source of prediction, and
re-coding source video data corresponding to the dropped buffered coded data using different reference frame(s) as a source of prediction.

7. A method for adapting video coding to changing network conditions, comprising:
in a stable network state, coding video data according to coding parameters that match an estimate of network bandwidth, the coding involving coding select source data elements as prediction references for coding of other source data elements;
in an unstable network state, coding the video data according to coding parameters of the stable network state but with a reduced rate of prediction references as compared to the network state;
buffering coded data generated during the stable network state and the unstable network state for transmission via a network; and
in a network diminished state, selectively decimating buffered non-reference coded data.

8. The method of claim 7, further comprising, in the network diminished state, revising the estimate network conditions and revising coding parameters to match the revised estimate.

9. The method of claim 7, further comprising, in the network unstable state, identifying decimated data to the encoder for use in subsequent coding operations.

10. The method of claim 7, wherein
in the unstable network state, the coding reduces the number of reference frames in the coded video data, and
in the network diminished state, non-reference frames are decimated.

11. The method of claim 7, wherein
in the unstable network state, the coding reduces the number of reference slices in the coded video data, and
in the network diminished state, non-reference slices are decimated.

12. The method of claim 7, wherein
in the unstable network state, the coding engages scalable video coding, coding source video data as coded base layer data and coded enhancement layer data, and
in the network diminished state, coded enhancement layer data is decimated.

13. The method of claim 7, further comprising, in the network diminished state,
decimating buffered reference frame data, and
recoding source video data corresponding to decimated reference frame data as non-reference frame data.

14. The method of claim 13, further comprising:
decimating buffered coded data that relies on the decimated reference frame data as a source of prediction, and
recoding source video data corresponding to the decimated buffered coded data using different reference frame data as a source of prediction.

15. A video coder system comprising:
a video coder to code source video data according to coding parameters, the coded video data including reference data that is a source of prediction for other coded video data,
a transmit buffer to store coded video data prior to transmission,
a transmitter to read out coded video data from the transmit buffer and transmit it over a network,
a network monitor to estimate network conditions,
a buffer controller to selectively decimate non-reference data from the transmit buffer based on estimated network conditions, and
a coder controller to establish the coding parameters for the video coder based on the estimated network conditions and indicators of decimated data from the buffer controller.

16. The video coder system of claim 15, wherein, when the estimated network conditions indicate network instability, the coder controller reduces a number of reference frames generated by the video coder.

17. The video coder system of claim 15:
wherein, when the estimated network conditions indicate network instability, the coder controller reduces a number of reference slices in the coded video data,
wherein the decimation is performed on non-reference slices of the coded enhancement layer data.

18. The video coder system of claim 15:
wherein, when the estimated network conditions indicate network instability, the coder controller engages scalable video coding by the video coder, causing the video coder to code source video data as coded base layer data and coded enhancement layer data, and
wherein the decimation is performed on frames of the coded enhancement layer data.
The video coder system of claim 15, wherein the video coder system is a component of a videoconferencing terminal.

19. The video coder system of claim 15, wherein the video coder system is a component of a mobile terminal.

20. Computer readable medium storing program instructions that, when executed by a processor, cause the processor to:
detect non-reference frames in a transmit buffer awaiting output to a network;
drop one or more of the non-reference frames from the transmit buffer when network degradation is detected; and
generate information about the dropped frames to an encoder for updating buffer parameters for future encoding.

21. The computer readable medium of claim 20, wherein the instructions further cause the processor to, prior to detection of the network degradation:
code video data according to predictive coding techniques, the coding generating non-reference frames and reference frames,
detect network instability, and
when network instability is detected, code the video data by a decreased number of reference frames.

22. The computer readable medium of claim 20, wherein the instructions further cause the processor to, prior to detection of the network degradation:
code video data according to predictive coding techniques, the coding generating non-reference frames and reference frames,
detect network instability, and
when network instability is detected, engage scalable video coding in the encoder to code source video data as coded base layer data and coded enhancement layer data,
wherein the dropping is performed on frames of the coded enhancement layer data.

23. The computer readable medium of claim 20, wherein the instructions further cause the processor to, prior to detection of the network degradation:
code video data according to predictive coding techniques, the coding generating non-reference slices and reference slices,
detect network instability, and
when network instability is detected, code the video data by a decreased number of reference slices.
